(19) United States
(12) Patent Application Publication
(10) Pub. No.: US 2002/0016180 A1
(43) Pub. Date: Feb. 7, 2002

(54) Communication device intervention system and method

(76) Inventors: J. David Derosier, Osterville, MA (US); Kris Hatashita, Kanata (CA)

Correspondence Address: Iandiorio & Teska, 260 Bear Hill Road, Waltham, MA, 02451-1018, US

(21) Appl. No.: 09/912,900

(22) Filed: Jul. 25, 2001

Related U.S. Application Data
(60) Provisional application No. 60/220,686, filed on Jul. 25, 2000.

(51) Int. Cl. H04B 7/00

(52) U.S. Cl. 455/522; 455/434; 455/435

(57) ABSTRACT

A method of and system for intervening between a wireless communication device and a base station. A receiver is used to scan for transmissions from multiple surrounding base stations. The absolute field strength of all received transmission is measured and the information transmitted by the base stations is recorded. Then the transmission power level of a transmitter is set to have an absolute field strength greater than the highest measured absolute field strength detected from a corresponding base station. When an interface signal from a wireless communication device is received, the corresponding information is transmitted to the wireless communication device to thereafter control the wireless communication device by establishing a communication channel between the wireless communication device and the receiver and transmitter instead of between the wireless communication device and a surrounding base station to prevent use of the wireless communication device proximate the receiver and transmitter.

### RELATED APPLICATIONS

This application claims priority of Provisional Patent Application Serial No. 60/220,686 filed Jul. 25, 2000. That application is herein incorporated by reference in its entirety.

### FIELD OF THE INVENTION

This invention relates to a communication device intervention system and a method of intervening between a wireless communication device and a base station so that, for example, a cellular telephone cannot be used in a predefined area for safety and security reasons and also to prevent the use of cellular telephones in restaurants and other meeting places where they are considered a nuisance.

### BACKGROUND OF THE INVENTION

Wireless communication devices such as cellular telephones conveniently provide the ability to establish communications in many places but also cause a nuisance in restaurants and other meeting places such as court houses. Moreover, for safety and security reasons, cellular telephones are prohibited in aircraft, hospitals, and secure buildings and offices.

Banning cellular telephones, however, does not always work and shielding certain spaces to prevent incoming calls to and outgoing calls from a cellular telephone is often cost prohibitive. In the prior art, Blue Linx of North Carolina advertises a product called “Q-Zone”. The “Q-Zone” device communicates with cellular telephones within its area of jurisdiction and turns down their ringers. Unfortunately, this method requires that the manufacturer of the telephone device participate by including hardware that can receive these communications. Moreover, this method does not prevent individuals from placing outgoing calls or receiving a phone call from a vibration rather than a ringer.

Also in the prior art is Morse Medical Inc. and Zetron's “Cell Phone Detector Plus” products which detect the presence of a cellular phone and send an alarm when one is present. Unfortunately, these detection schemes do not provide assurances that a person will turn off a cellular telephone or refuse to use it.

Jamming is another prior art technique for preventing use of a cellular telephone or other wireless communication device. In the United States, however, jamming is illegal. In other countries, such as Japan, jamming cellular telephones is restricted to theaters or concert halls where the degree of public nuisance is significant. Accordingly, jamming techniques cannot be universally employed.

Netline Technologies of Israel developed the “C-Guard” product which uses a high radiation signal to effectively “scramble” a cell phone signal. This device is also illegal in the United States. Another jamming device is Medic Inc.'s “Wave Wall” product introduced in 1998.

ViperCell is a product created by a company called Jet Cell. Cisco Systems recently acquired JetCell. ViperCell converts cellular telephone communication into Internet Protocol (voice-over-IP) and connects to a local area network (LAN) using Ethernet technology. This technology will give employees the ability to use a standard cellular telephone to access their corporate voice services and roam between their private corporate network and public cellular networks with uninterrupted service. This product is not competitive with Cell-Block-R Systems because it performs different functions.

### SUMMARY OF THE INVENTION

It is therefore an object of this invention to provide a more universally acceptable communication device intervention system and method.

It is a further object of this invention to provide such a system and method which does not require modifications to the hardware and software of standard cellular telephones.

It is a further object of this invention to provide such a system and method which provides assurance that the cellular telephone or other wireless communication device cannot be used either to receive incoming calls or to transmit outgoing calls.

It is a further object of this invention to provide such a system and method which do not involve illegal jamming techniques.

It is a further object of this invention to provide such a system and method which eliminates the nuisance of cellular telephones and other wireless communication devices in restaurants and other meeting places.

It is a further object of this invention to provide such a system and method which ensure, for safety and security reasons, that cellular telephones or other wireless communication devices are not purposely or inadvertently used in secure areas, on board airplanes, in hospitals, and the like.

This invention results from the realization that wireless communication devices such as cellular telephones can be effectively controlled in secure areas or any place where they are deemed an annoyance but also not interfered with outside of a predefined area without jamming by a control unit which tricks the wireless communication device into believing it has established a communication channel with the base station of a nearby cellular tower.

By measuring the absolute field strength of all received transmissions output by surrounding base stations and recording the information transmitted by the base stations, the control unit of the subject invention sets the power level of its transmitter to have an absolute field strength greater than the highest measured absolute field strength detected from a corresponding base station. Then, the wireless communication device transmits an interface signal, anticipating a response from the base station. The control unit then transmits a signal back to the wireless communication device mimicking the signal which would be transmitted by an actual base station. But, since the wireless communication device believes the control unit is a base station, the control unit is able to control the wireless communication device to prevent incoming or outgoing calls.

This is accomplished by instructing the wireless communication device to lower its transmission power so that further transmissions from the wireless communication device do not reach any corresponding surrounding base stations. In addition, the control unit may be capable of instructing the wireless communication device to transmit at a frequency not recognized by any corresponding surrounding base stations and/or by other means. In this way, wireless communication devices are intercepted and controlled instead of jammed and intervention occurs in a predefined area. When the user leaves that predefined area, the wireless communication device will establish communication with the service providers network and resume normal operation.

This invention features a method of intervening between a wireless communication device and a base station. The method comprises employing a receiver to scan for transmissions from multiple surrounding base stations; measuring the absolute field strength of all received transmission and recording the information transmitted by the base stations; setting the transmission power level of a transmitter to have an absolute field strength greater than the highest measured absolute field strength detected from a corresponding base station; receiving an interface signal from a wireless communication device; and transmitting to the wireless communication device the corresponding information to thereafter control the wireless communication device by establishing a communication channel between the wireless communication device and the receiver and transmitter instead of between the wireless communication device and a surrounding base station to prevent use of the wireless communication device proximate the receiver and transmitter.

The step of transmitting may include instructing the wireless communication device to lower its transmission power so that transmissions from the wireless communication device do not reach any corresponding surrounding base stations. Alternatively, or in addition, the step of transmitting may include instructing the wireless communication device to transmit at a frequency not recognized by any corresponding surrounding base stations and/or other means of disrupting normal operation. In an additional alternative, or in addition, the step of transmitting may include instructing the wireless communication device to undertake to remove itself from normal communication with a cellular telephone service provider.

Further included may be the steps of keeping a record of all interface signals and requests for service transmissions received from a wireless communication device, polling the record to track movement of a wireless communication device, and providing an alarm when a wireless communication device transmits a request for service transmission.

The method of intervening between a wireless communication device and a base station in accordance with this invention typically includes employing a receiver to scan for transmissions from multiple surrounding base stations; receiving an interface signal from a wireless communication device; and transmitting to the wireless communication device the corresponding information to thereafter control the wireless communication device by establishing a communication channel between the wireless communication device and the receiver and transmitter instead of between the wireless communication device and a surrounding base station to prevent use of the wireless communication device proximate the receiver and transmitter.

The step of establishing a communication channel typically includes measuring the absolute field strength of all received transmissions and recording the information transmitted by the base stations. The step of transmitting then includes setting the transmission power level of a transmitter to have an absolute field strength greater than the highest measured absolute field strength detected from a corresponding base station.

A communication device intervention system in accordance with this invention includes an antenna; a receiver responsive to transmissions received by the antenna; a transmitter; and a control module. The central module is responsive to the receiver, connected to the transmitter, and measures the absolute field strength of all received transmissions detected by the receiver from surrounding base stations, records the information transmitted by the surrounding base stations, sets the transmission power level of the transmitter to have an absolute field strength greater than the highest measured absolute field strength detected from a corresponding base station, detects an interface signal received by the transmitter from a wireless communication device in a predefined area proximate the receiver, and transmits, at the set absolute field strength, the corresponding information to the wireless communication device so that the system prevents use of the wireless communication device in the predefined area.

The control module may be further configured to transmit to the wireless communication device a signal which instructs the wireless communication device to lower its transmission power so that transmissions from the wireless communication device do not reach any corresponding surrounding base stations. Alternatively, or in addition, the control module is configured to transmit to the wireless communication device a signal which instructs the wireless communication device to transmit at a frequency not recognized by any corresponding surrounding base stations other means. In an additional alternative, or in addition, the step of transmitting may include instructing the wireless communication device to undertake to remove itself from normal communication with a cellular telephone service provider. In one embodiment, the control module is configured to record all interface signals and requests for service transmissions received from a wireless communication device. A remote management unit (RMU) is then configured to poll the records of a selected group of control modules to track movement of a wireless communication device. Further included may be a system computer responsive to the remote management unit and configured to provide an alarm when a wireless communication device transmits a request for service transmission.

One communication device intervention system in accordance with this invention includes an antenna; a receiver responsive to transmissions received by the antenna; a transmitter; and a control module responsive to the receiver and connected to the transmitter. The control module is configured to record the information transmitted by the surrounding base stations, detect an interface signal received by the receiver from a wireless communication device in a predefined area proximate the receiver, and transmit the corresponding information to the wireless communication device so that the system prevents the use of the wireless communication device in the predefined area.

The transmitter has an adjustable power level and the control module is configured to measure the absolute field strength of all received transmissions detected by the receiver from the surrounding base stations, and further configured to set the transmission power level of the transmitter to have an absolute field strength greater than the highest measured absolute field strength detected from a corresponding base station. The control module is then configured to transmit at the set absolute field strength.

In a secure system, there may be a plurality of control units each having an antenna, a receiver responsive to transmissions received by the antenna, a transmitter having an adjustable power level and a control module responsive to the receiver and connected to the transmitter. The control module of each control unit is configured to measure the absolute field strength of a received transmission detected by the receiver from surrounding base stations, record the information transmitted by the surrounding base stations, set the transmission power level of the transmitter to have an absolute field strength greater than the highest measured absolute field strength detected from a corresponding base station, detect and record an interface signal received by the receiver from a wireless communication device in a predefined area proximate the receiver, and transmit, at the set absolute field strength, the corresponding information to the wireless communication device so that the system prevents the use of the wireless communication device in the predefined area. A remote management unit is then linked to the plurality of control units for polling the records of the control units to track movement of the wireless communication device and a system computer is responsive to the remote management unit for providing an alarm when the wireless communication device transmits a request for service transmission. The remote management unit may be linked to the plurality of control units via AC power lines. Typically, there are a plurality of remote management units each linked to a subset of the control units and the system computer is linked to the plurality of remote management units.

### BRIEF DESCRIPTION OF THE DRAWINGS

Other objects, features and advantages will occur to those skilled in the art from the following description of a preferred embodiment and the accompanying drawings, in which:

FIG. 1 is a schematic view showing a typical honeycombed pattern of hexagonal cellular phone system cells;

FIG. 2 is a schematic view of a central control site responsible for the overall control of a local cellular telephone system;

FIG. 3 is a schematic depiction of a cellular telephone transmitting an interface signal to a number of cellular tower base stations;

FIG. 4 is a schematic depiction of the cellular telephone tower base stations of FIG. 3 providing a response back to the cellular telephone;

FIG. 5 is a schematic depiction showing how the communication device intervention system of the subject invention also responds to the cellular telephone shown in FIGS. 3 and 4;

FIG. 6 is a schematic view of the communication device intervention system of the subject invention installed in a secure area or other area, for example, a restaurant, a meeting place, a hospital or other areas where cellular phone use is restricted/undesirable;

FIG. 7 is a flow chart depicting the primary steps of the setup portion of the method of intervening between a wireless communication device and a base station in accordance with the subject invention;

FIG. 8 is a flow chart depicting the primary steps associated with the method of the subject invention when the intervention system receives an interface signal from a cellular telephone proximate to it;

FIG. 9 is a block diagram showing the primary components associated with the communication device intervention system control unit of the subject invention;

FIG. 10 is a functional block diagram of the RF module block depicted in FIG. 9;

FIG. 11 is a functional block diagram of the protocol module shown in FIG. 9;

FIG. 12 is a functional block diagram depicting the UID module shown in FIG. 9;

FIG. 13 is a functional block diagram showing the secure module of FIG. 9;

FIG. 14 is a functional block diagram showing the primary components associated with the communication module of FIG. 9;

FIG. 15 is a functional block diagram showing the primary components associated with the control module of FIG. 9;

FIG. 16 is a schematic cross sectional view of a single communication device intervention control unit in accordance with the subject invention;

FIG. 17 is a schematic view showing a number of communication device intervention control units, a remote management unit, and a security system computer in accordance with one embodiment of the system of the subject invention;

FIG. 18 is a block diagram showing the primary components associated with the remote management unit system of the subject invention;

FIG. 19 is a flow diagram depicting the communications between a cellular phone (CP) and base station (BTS) or a control unit (CU); and

FIG. 20 is a system flow diagram depicting the communications between a cellular phone (CP) and BTS or a secured control unit (CU-S).

### DISCLOSURE OF THE PREFERRED EMBODIMENT

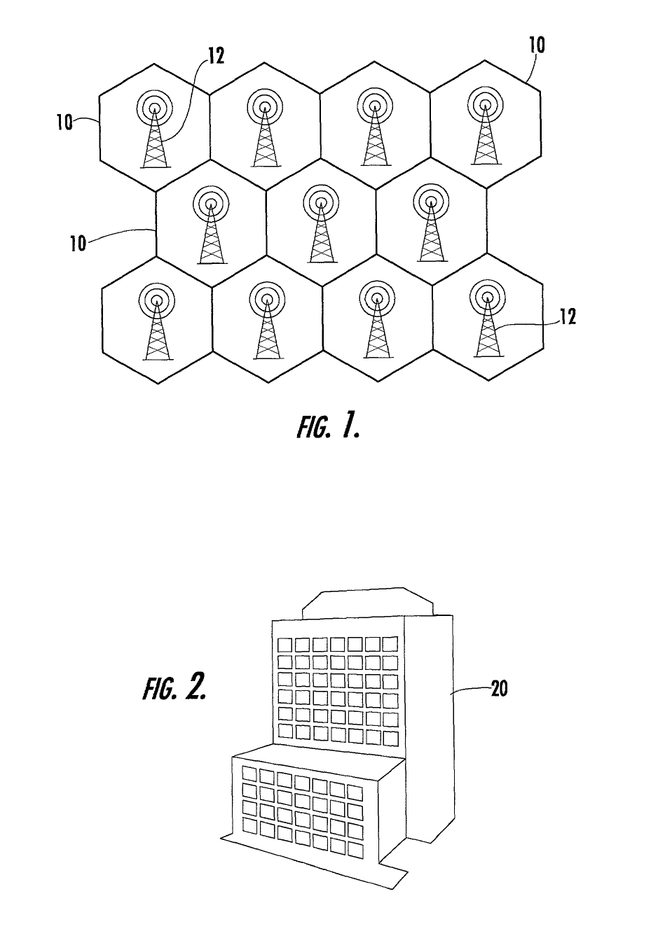

A typical cellular telephone system consists of many small service areas called “cells” 10, FIG. 1. The system is typically depicted as a honeycomb pattern of hexagonal cells as shown in FIG. 1 and a base station 12 typically services each cell.

Each base station contains a transmitter, a receiver, and related control equipment for the channels assigned to that cell. Usually, not all the cells use all the frequencies allocated to that cellular system.

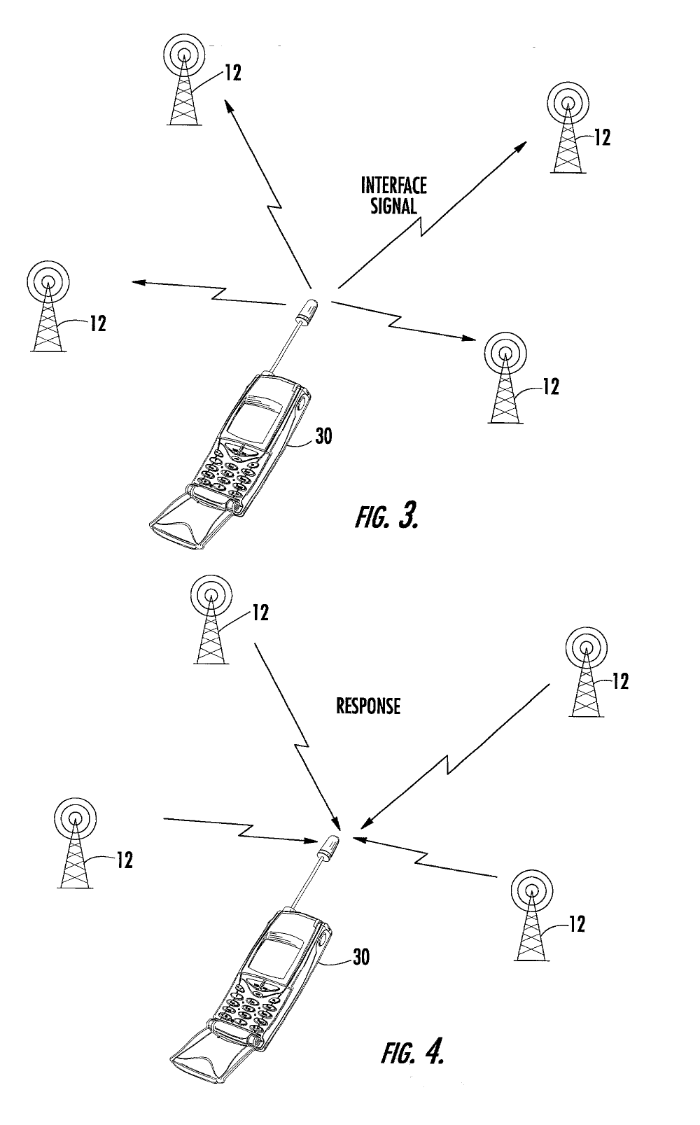

A central control site 20, FIG. 2 is responsible for the overall control of the local cellular system and coordinates all interactions between individual phones and the base stations. The central control site is in communication with all the base stations within its system and handles the interface with the land line network, microwave links, or a combination of the two. A cellular system transmits and receives over assigned channels or frequencies. These channels are divided into two general categories: control channels and voice channels.

Control channels are digital only and are used for forward control, paging, access, and control and data transfer. Forward control channels provides basic information about the particular cellular system such as the identification number and the range of channels available which the cell phone can scan to find paging and access channels. Paging channels are the normal holding frequencies for idle cellular telephones. When a call is received at a central control site, the paging signaling will occur on a paging channel. The access channel responds to a page or, when originating a call, the cell phone will use an access channel where two-way data transfer occurs to determine the initial voice channel. Control and data transfer is the digital signaling employed to effect cell to cell hand-offs, output power control on the cellular telephone, and special local control features.

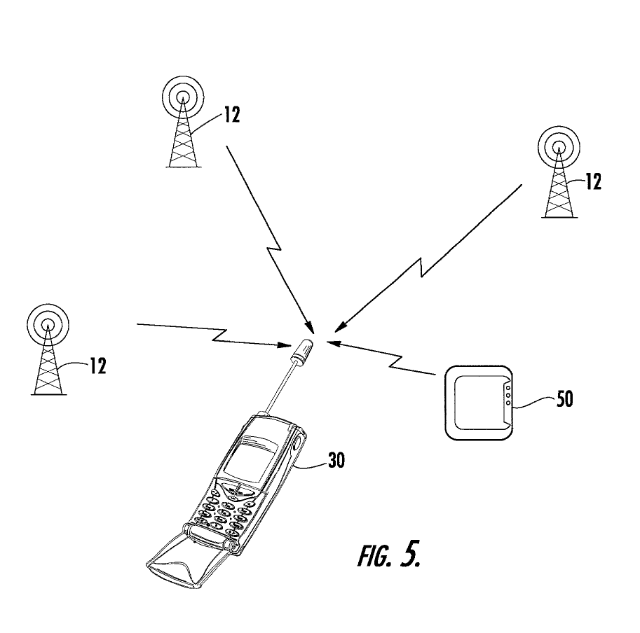

When cellular telephone 30, FIG. 3, is turned on, it looks to find out where it is and what base station will be able service it. It does this by sending and receiving “pings” or “interface signals” which carry digital-only information identifying the cellular telephone and the various cells within the honeycomb system which can service it. The strength of the base station signal as received by the cellular telephone is a function of the actual signal strength, the distance between the two, and the surrounding environment.

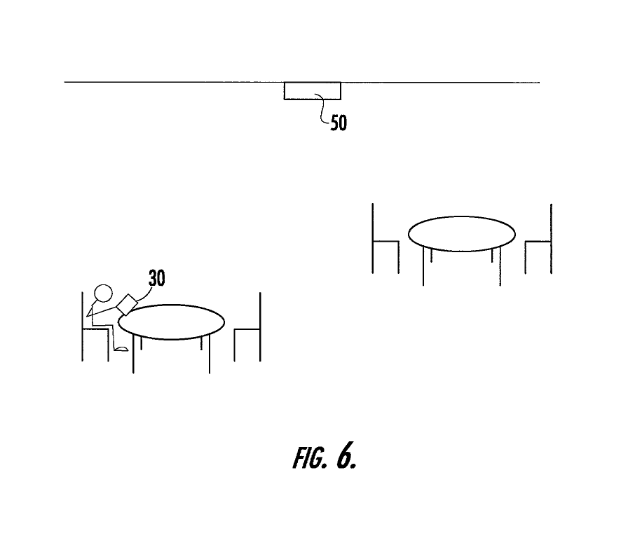

When the cellular telephone sends out its interface signal, all base stations 12 within the range of the cellular telephone receive that signal which contains identification information. Each of the base stations that receive the interface signal then send out a response to the cellular telephone as shown in FIG. 4.

As the response signals are received from the base stations, the cellular telephone is able to measure the relative field strengths of the signals. The station with the strongest signal is likely to provide the clearest communication channel. Once the cellular telephone establishes which base station has the strongest signal, it normally engages that station with further communications.

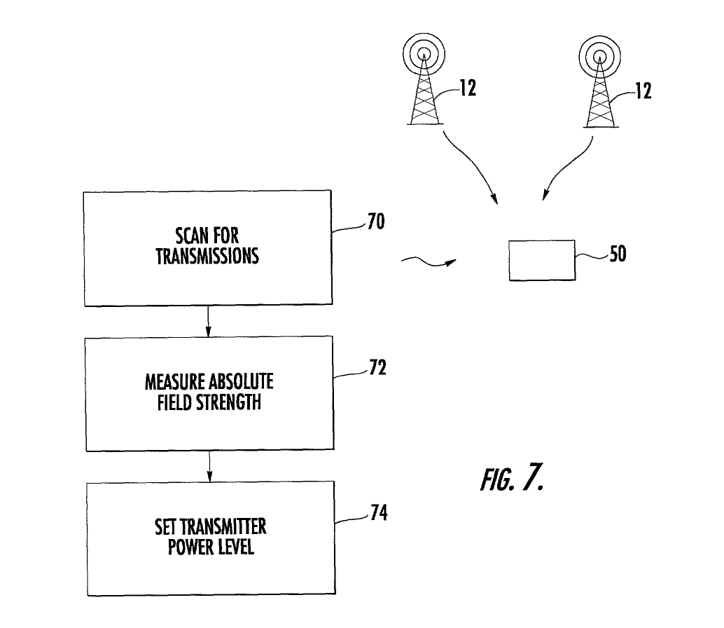

Communication device intervention system 50, FIG. 5 of this invention is programmed to respond to the interface signal of cellular telephone 30 as if system 50 was actually a base station. If cellular telephone 30 is close enough to device 50, the response signal of device 50 will be the strongest signal received by the cellular telephone 30. Once cellular telephone 30 accepts device 50 as the controlling base station, device 50 and cellular telephone 30 can then engage in a communication protocol and will continue to do so as long as cellular telephone 30 is within the effective zone of device 50. This effective zone can be tailored from a radius of a few feet to several yards.

By measuring the absolute field strength of all the base stations 12 in the area of device 50 and by recording the information transmitted by the base stations, the transmission power level of the transmitter of device 50 can be set to have an absolute field strength greater than the highest measured absolute field strength detected from a corresponding base station 12. Then, when the interface signal is received from a wireless communication device, such as cellular telephone 30, device 50 transmits to it the appropriate information to thereafter control the wireless communication device by establishing a communication channel between the wireless communication device (e.g., cellular telephone 30) and the receiver and transmitter of device 50 instead of between cellular telephone 30 and surrounding base stations 12 to prevent the use of cellular telephone 30 proximate the receiver and transmitter of device 50.

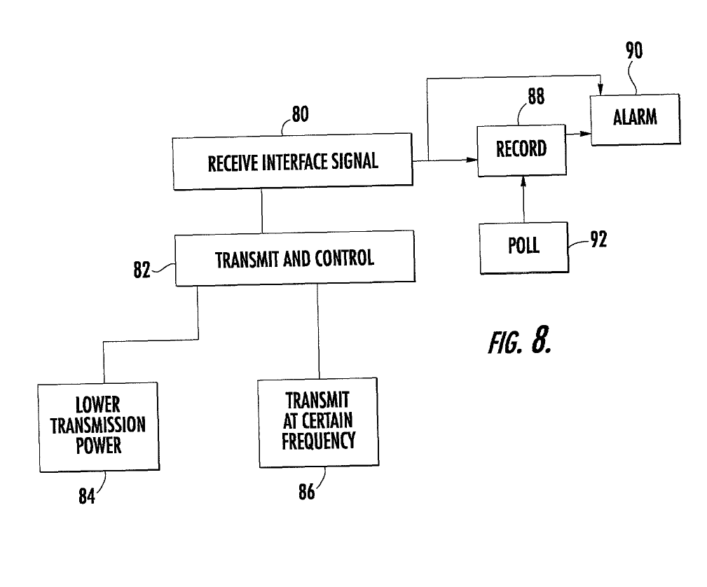

Device 50 is shown in FIG. 6 mounted on the ceiling of a restaurant, or a secure area, or any place where cellular telephone use is not desired or prohibited.

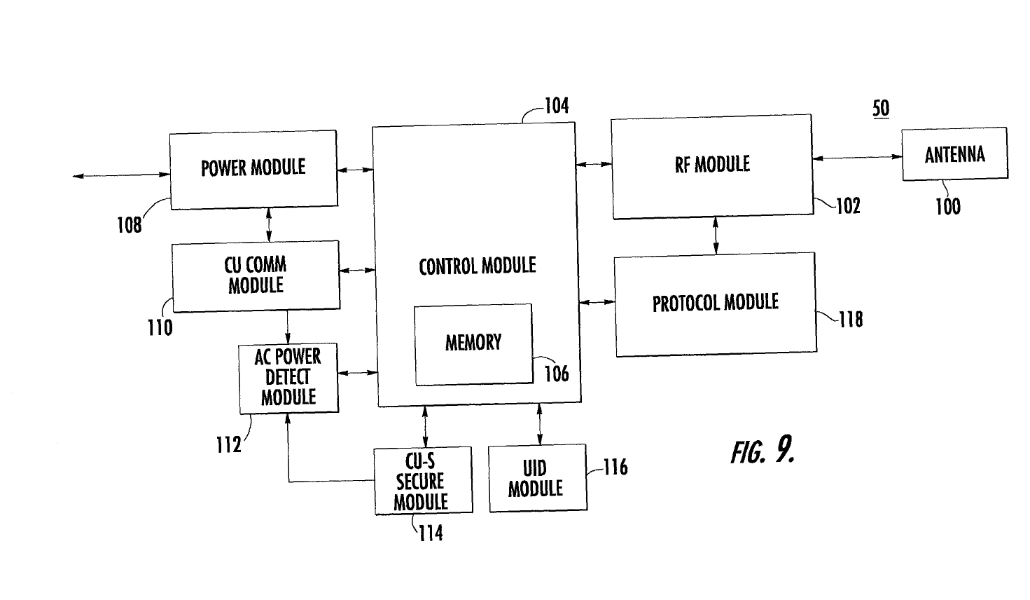

The primary steps of the method of the subject invention are shown in FIG. 7. In step 70 the receiver of device 50 is used to scan for transmissions from multiple surrounding base stations. Then, a control module measures the absolute field strength of all the received transmissions and records the information transmitted by the surrounding base stations, step 72. In step 74, the transmission power level of the transmitter of device 50 is then set to have an absolute field strength greater than the highest measured absolute field strength detected from a corresponding base station 12.

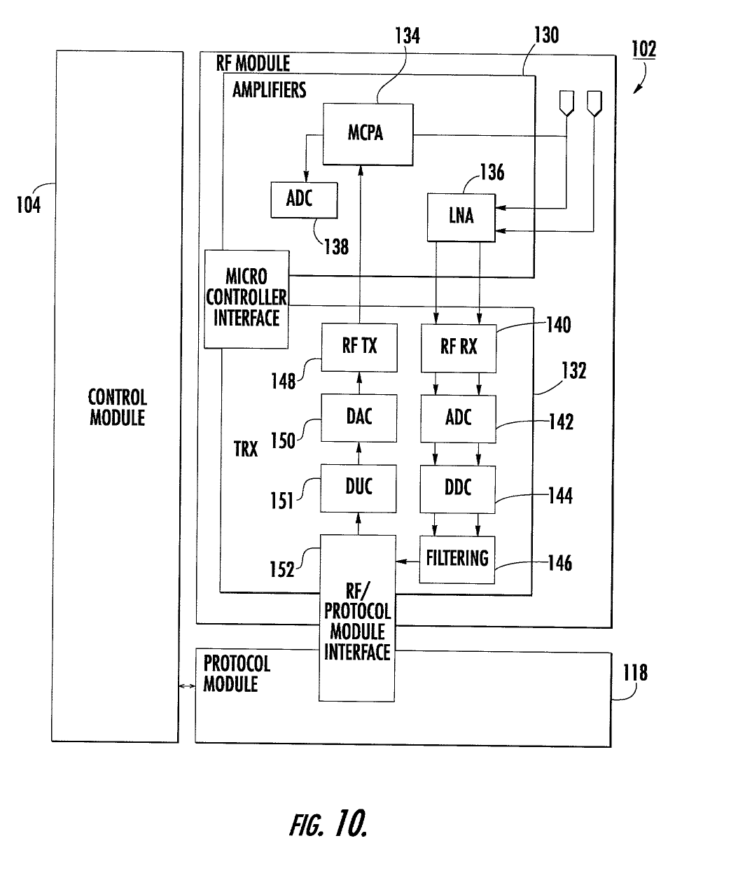

Once the device is thus initialized, the transmitter will receive interface signals from any wireless communication device in proximity to it, step 80, FIG. 8. In step 82, the proper information is then transmitted to the wireless communication device to thereafter control it by establishing a communication channel between the wireless communication device and the receiver and transmitter of device 50, FIGS. 5-7 instead of between the wireless communication device and a surrounding base station to prevent use of the wireless communication device proximate the receiver and transmitter.

In one example, the system of this invention instructs the wireless communication device to lower its transmission power to the lowest setting so that transmissions from the wireless communication device do not reach any surrounding base stations, step 84, FIG. 8. In another example, the wireless communication device is instructed to transmit at a frequency not recognized by any corresponding surrounding base stations, step 86. Also, for security measures, whenever an interface signal is received from a wireless communication device, that information can be stored, step 88 and recorded and/or an alarm can be sounded, step 90. In one embodiment, there are a number of communication device intervention control units throughout a given facility. By polling the records of each such unit as shown at step 92 a person attempting to improperly use a cellular telephone in a secure area can even be tracked using additional methods.

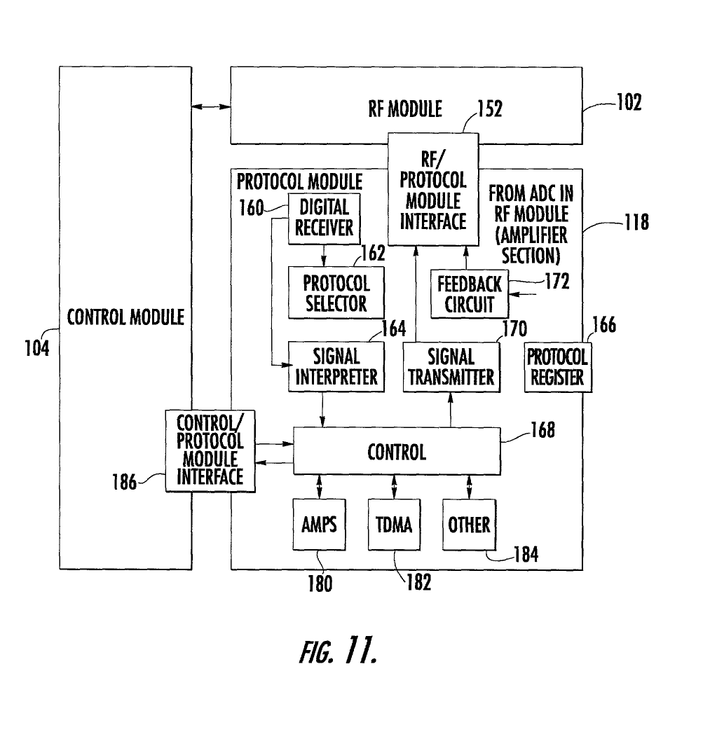

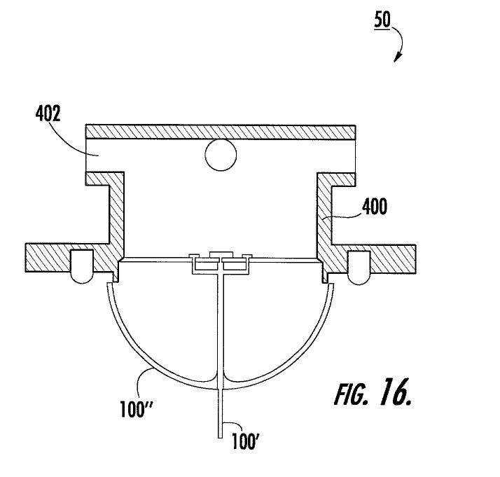

Device 50, FIG. 9 includes antenna 100, and RF module 102 which itself includes a receiver responsive to transmissions received by antenna 100 and also a transmitter having an adjustable power level. Control module 104, which may be embodied in micro-controller 240, FIG. 15, and an Erasable Programmable Logic Device (EPLD), is responsive to the receiver of RF module 102 and connected to the transmitter of RF module 102. RF module 102 is also programmed or otherwise configured to measure the absolute field strength of all received transmissions detected from surrounding base stations. Control module 104 records the information transmitted by the surrounding base stations and stores that information in memory 106.

Control module 104 also sets the transmission power level of the transmitter of RF module 102 to have an absolute field strength greater than the highest measured absolute field strength detected from a corresponding surrounding base station. Control module 104, responsive to the receiver of RF module 102, is then able to detect interface signals received by the receiver from a wireless communication device in a predefined area proximate antenna 100. Control module 104 then causes the transmitter of RF module 102 to transmit, at the set absolute field strength, the corresponding information to the wireless communication device so that the system prevents the use of the wireless communication device in that predefined area. Control module 104 can be programmed or otherwise configured to transmit to the wireless communication device a signal which lowers the transmission power of the wireless communication device so that later transmissions from the wireless communication device do not reach any corresponding surrounding base stations.

Control module 104 may alternatively or in addition be configured to transmit to the wireless communication device a signal which instructs the wireless communication device to transmit at a frequency not recognized by any corresponding surrounding base stations. Control module 104 may alternatively or in addition be configured to transmit to the wireless communication device a signal which instructs the device to under take another sequence of instructions that has the same effect as removing the wireless communication device from the network.

Device or control unit 50 FIG. 9 comprises a low-power transmitter/receiver used to communicate with the cellular telephone within its effective control range to prevent the cellular telephone from establishing regular cellular service. Control unit 50 instructs the cellular telephone within its effective control range to reduce its transmission power to a minimum level, or to wait on a frequency where no incoming calls will be received and from which no outgoing calls can be processed, or undertake another course of action that will result in the cellular phone becoming inoperative or unable to process calls normally.

While the cellular telephone is within the jurisdiction of control unit 50, it is not considered as being “on” to the regular (outside) cellular system to which it had been connected outside the influence of control unit 50. Therefore, any calls or messages that would have been receivable by the cellular telephone would be handled by the regular cell system in the same manner as if the cellular telephone had been turned off.

While the cellular telephone is within the jurisdiction of control unit 50 and is turned “on”, it may display a message indicating that there is no service available. Such an “on” device will have its identity recorded in memory 106 with the date and time. Any attempted outgoing calls requested will be ignored by control unit 104 and ignored by the regular cellular system to which it had been connected prior to coming within the control of control unit 50. Thus, these outgoing calls will not be placed. Moreover, if an attempt is made to place an outgoing call, control unit 50 can be programmed to send an immediate alarm message to a remote management unit, discussed infra. This function is implemented on secure versions of the system of this invention.

The remote management unit then communicates with the individual control units utilizing network protocol over the power mains of the facility where the system is installed. The remote control unit may periodically poll the control units to ensure that they are all working properly. The remote management units can also poll the control units for a memory dump, activation of a clear memory-sequence, and also receives any alarms sent by a control unit if a security breach occurs. One or more remote management units can also be connected to a personal computer in a large integrated security system. The personal computer in the system contains software, tailored to the specific installation site, to manipulate and utilize the data presented by the system of this invention.

Control unit 50 further includes power module 108, an AC to DC converter which provides power to the other modules of control unit 50. CU communication module 110 allows control unit 50 to communicate via power line communications with other sub-systems of the subject invention. AC power detect module 112 prevents unauthorized use of control unit 50. Secure module 114 may be included for secure implementations of control units 50. Unique identifier module (UID) 116 which may include an EPROM which functions to store the identification information for a particular control unit. Protocol module 118 contains the circuitry and/or programming required to record the appropriate Time Division Multiple Access (TDMA), Code Division Multiple Access (CDMA), or other type of signal formats transmitted by surrounding base stations and cellular telephones or other wireless communication devices proximate antenna 100.

RF module 102 transmits and receives information between the cellular telephone and control module 104. RF module 102 is controlled by control module 104. RF module 102 has two different functions, which are to transmit and receive RF signals in the cellular telephone frequency ranges. RF module 102 may also have an automated self-test procedure. RF module 102, shown in more detail in FIG. 10, is implemented in two main sub-modules, amplifier sub-module 130 and transmit/receive (TRX) sub-module 132. Amplifier sub-module 130 includes multi-carrier power amplifier (MCPA) 134, low-noise amplifier (LNA) 136, and analog-to-digital converter (ADC) 138. MCPA 134 is a commercially available component designed to transmit over different cellular telephone frequencies. These frequencies will change when new frequency bands are made available for commercial licensing. MCPA 134 is also implemented to meet the guidelines set forth by the AFCC and the CRTC with regard to maximum transmission levels allowable. MCPA 134 also has a variable programmable gain that is controlled by control module 104. The variable gain nature of variable MCPA 134 is necessary to overcome noise levels projected by nearby cellular tower base stations and to ensure that the operating radius of the system of this invention is within the specified target range.

LNA 136 increases the level of a weak incoming RF signal without significantly degrading the signal-to-noise ratio and without introducing non-linearities in the signal gain that generate undesired intermodulation products. ADC 138 converts the incoming RF signal to a digital time domain signal so that it can be filtered and decoded later in the circuit. TRX sub-module 132 includes six primary components: radio-frequency receiver (RFRX 140), analog-to-digital converter (ADC 142), digital down-converter (DDC 144), digital filtering circuitry 146, radio-frequency transmitter (RFTX 148), digital-to-analog converter (DAC 150), and control/protocol module interface circuitry 152.

RFRX 140 is an RF receiver capable of receiving frequencies within the cellular telephone frequency bands. RFRX 140 demodulates any received RF signal and outputs the base-band signal originally transmitted by the cellular telephone. ADC 142 converts the incoming base-band signal to a digital time domain signal so that it may be filtered and decoded later in the circuit.

DDC 144 is a digital receiver capable of receiving, tuning, and tracking control signals from a cellular telephone within the jurisdiction of the system. DDC 144 first digitizes the entire spectrum of carriers from the cellular telephone frequency bands. It then digitally selects the carrier of interest, tunes in, and tracks it. DDC 144 also provides other features such as filtering through the use of a received signal processor (RSP). After tuning the channel, DDC 144 provides filtering by removing unwanted signals and noise on the channel of interest with the RSP.

Filtering circuitry 146 includes a digital signal processor used to filter the incoming signal. The digital signal processor of filtering circuitry 146 also performs error correction and cross-correlation so that the signal can be easily decoded and interpreted further on in the circuitry. RFTX 148 is an RF transmitter capable of transmitting in the frequency bands of the cellular telephone control signals. RFTX 148 performs the RF modulation from internally generated carrier signals. DAC 150 converts the outgoing digital signal into an analog phase-shifted key (PSK) signal as the intermediate modulation step for RFTX 148. Digital up converter or DUC 151 is the first stage of the conversion of the digital signal to the base-band signal prior to modulation. DUC 151 implements a cyclic redundancy check (CRC) error correction in the signal and increases the band width of the signal prior to a conversion to a PSK analog signal. RF protocol module interface 152 includes several transceivers capable of receiving data in the appropriate ranges.

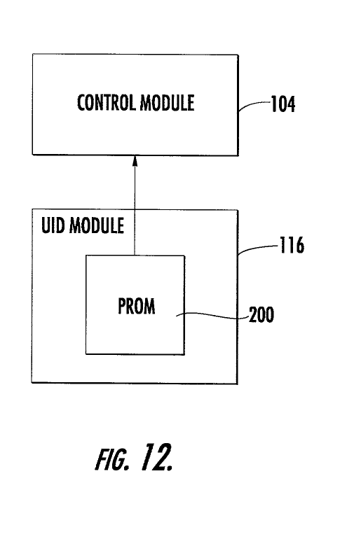

Protocol module 118, FIGS. 9 and 10 shown in more detail in FIG. 11. Protocol module 118 functions generally to carry out specialized communications between device 50, FIG. 9 and the cellular telephone. Protocol module 118 deciphers and encodes information using various communication wireless protocols. Digital receiver 160 receives the signal from RF/protocol module interface 152 and converts it into the appropriate digital form so that the signal can be later read and manipulated by the rest of protocol module 118.

Protocol selector (PS) 162 is utilized during the initial interface signal of the cellular telephone to determine which protocol the cellular telephone is using to communicate. PS 162 then sets corresponding bits in a register that will be used by signal interpreter (SI) 164 and other sub-modules to determine which protocols to use in their decoding and intervention routines. Signal interpreter 164 receives the digital information from digital receiver 160, checks protocol register (PR) 166 for the proper protocol to use, then interprets the signal so that the control sub-module 168 can respond to it. Digital transmitter 170 takes the output from control module 168 and translates it into a format that RF module 102 can transmit. Feedback circuit 172, implemented in a digital signal processor, compares the signals transmitted from the antenna 100, FIG. 9 and the original signal to check for distortion. If there is distortion, feedback circuit 172 then implements various filters to correct for the distortion in the transmitted signal.

Thus, feedback circuit 172 is used in the initial setup and also during self-test phases of the operation of the system of the subject invention. Control sub-module 168 receives the interpreted signal from signal interpreter 164. Control sub-module 168 then checks protocol register 166 to see what protocol to use in response. Control module 168 is then programmed to extract the cellular telephone's PID and other information and transmit it to control module interface 186. Control sub-module 168 then receives an assigned frequency from micro-controller 240, FIG. 15, that will transmit back to the cellular telephone. Control sub-module 168 is also responsible for signaling the cellular telephone to switch to a power down or sleep mode as well as any other protocol communication that is required.

AMPS sub-module 180 deciphers and encodes the AMPS protocol function and responds to control sub-module 168 to provide communication signals that the cellular telephone can properly interpret. TDMA sub-module 182 deciphers and encodes all TDMA protocols and functions. Sub-module 184 called “other” in FIG. 11 functions in a manner similar to AMPS sub-module 180 and TDMA sub-module 182 and is implemented when other protocols are needed for cellular telephone intervention including, but not limited to, CDMA, GSM and the like. Control/protocol module interface 186 functions to ensure that outgoing signals comply with the appropriate protocol by assembling the information to be transmitted by the device. Interface 186 also ensures that incoming signals conform to the interface protocol and assigns information packets to the appropriate output buffers. Protocol register 166 sets and resets the registers that correspond to the appropriate protocols as used throughout the communication process to determine the appropriate protocol signals.

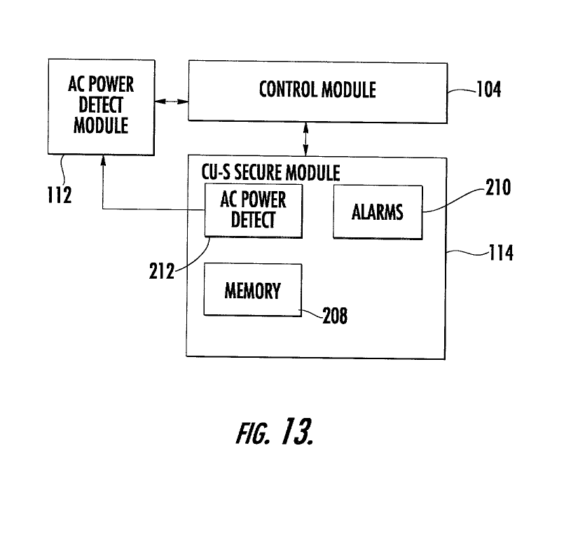

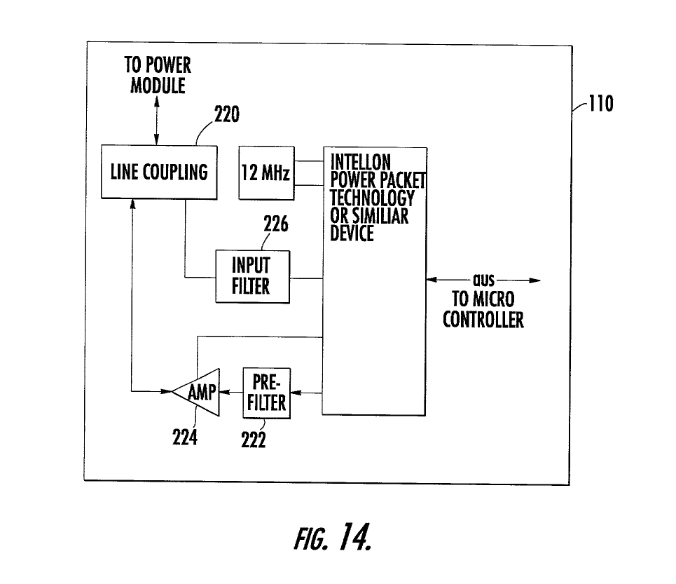

UID module 116 is shown in more detail in FIG. 12. UID module 116 includes PROM 200 preprogrammed with the unique 8-bit identity which cannot be changed. CU-S secure module 114, FIG. 9, is shown in more detail in FIG. 13. Module 114 enables secure functions such as alarms and recording features and is capable of storing cellular telephone UIDs in random access memory 208. Secure module 114 also enables alarm circuitry 210 and regulates the controls AC power detect module 112 in certain circumstances. Secure module 114 can be implemented in a micro-controller to include functional sub-modules 210, 208, and AC power detect sub-module 212.

Alarm sub-module 210 triggers an alarm if there is a security breach of the system and establishes the connections that will warrant an alarm for example, when a cellular telephone attempts to transmit an outgoing call or if there is a failure of a built in test or a periodic built in test. Memory functional block 208 records events and transmissions from a cellular telephone including information such as the cellular telephone's PID, the time it entered into the jurisdiction of the system, the time it exited the jurisdiction of the system, and multiple instances of entry and exit into the same jurisdiction. AC power detect submodule 212 controls and regulates AC power detect module 112 when functioning in a secure system embodiment of the subject invention. Sub-module 212 sends an encrypted signal to AC power detect module 112, the same signal that is sent by the remote management unit discussed below.

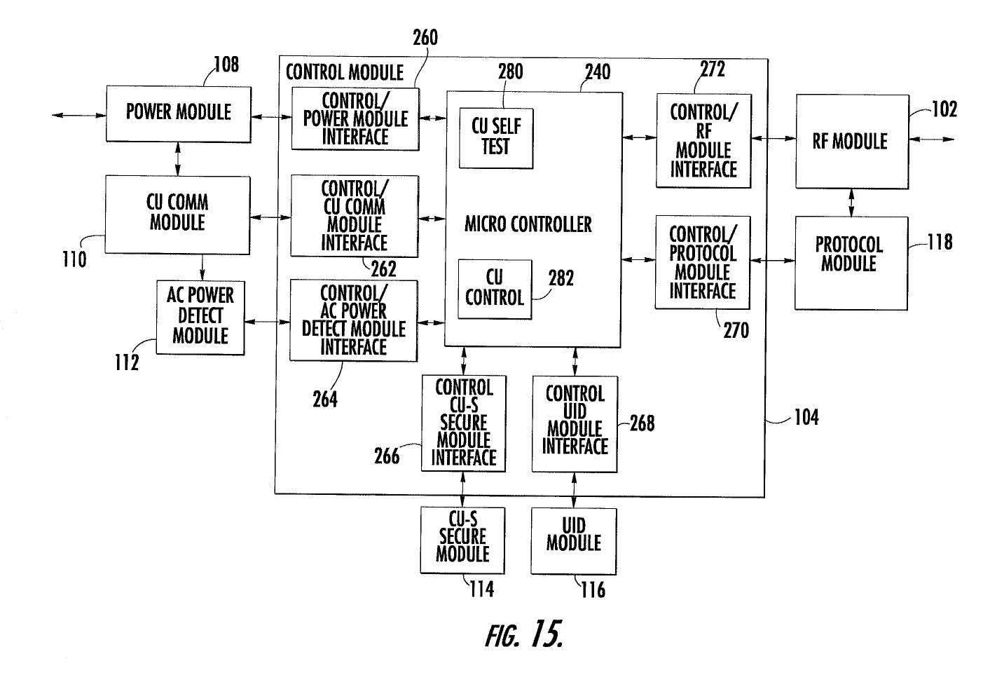

CU communication module 110, shown in more detail in FIG. 14, is responsible for transmitting and receiving information between the remote management unit discussed below and each individual device 50, FIG. 9, of the subject invention. Module 110 communicates over the power lines using network protocol over power mains (NPOPM) signal protocols. The main component of module 110 is power packet technology from the Intelon Corporation or a similar device from another manufacturer performing similar functions. In one example, the Intelon SSC P300 PL network interface controller is a highly integrated powerline transceiver and channel access interface for implementing CEBus standard compatible products. The SSC P300 provides a data link layer (DLL) control logic for EIA-600 channel access in communications services, a spread spectrum carrier (SSC) power line transceiver, signal conditioning circuitry, and an SPI compatible host interface.

The host micro-controller interprets commands and performs end-to-end protocol functions. Output signal amplification and filtering, input signal filtering, and node coupling to the power lines is accomplished using external components. The SSC P300 interface to the host system is supported through a serial peripheral interface (SPI) using five I/O lines. A hardware, active-low, reset (RST*) signal is also supplied by the host system. The protocol is used to transfer commands and data between the host and the SSC P300. These commands and data include packets to be transmitted, received packets, status and configuration information.

Analog data is transferred between the AC power line and the SSC P300 over the signal in (SigI) and signal out (SigO) pins. In the transmit mode, the SSC “chirps” from the SSC P300 SO pin are routed to the output amplifier, which is enabled by the SSC P300 tri state (TS) signal. Once amplified, the output signal passes through a low-pass output filter, which removes harmonic energy (distortion) from the transmits signal, and on to the tri state switch. This switch is also enabled by the SSC P300 TS signal and serves to isolate the amplifier and filter from the power line coupling circuit during receive operations. When the tri state switch is enabled, the power line communication signal is routed to the 68Z power line through the power line coupling circuit.

The line coupling section 220 of CCOMM couples the CU to the AC mains using a high-pass, toroidal coupling transformer. Pre-filter section 222 filters the input signal to amp section 224 to minimize the noise that will be amplified and transmitted over the power lines. Filter 222 can be implemented in a DSP if there is space in an existing device to save costs and circuit board real estate. Input filter 226 includes a band pass filter (100 to 400 KHz) that passes the “chirp” frequency to Intellon power pocket technology 223, FIG. 14. Again, input filter 226 can be implemented in a DSP.

Power module 108, FIG. 9 converts AC line voltage to the required DC voltage for operation of the electronic components of control module 104. Power module 108 also signals control module 104 and disables the device if it is not properly connected to AC power lines.

A more detailed depiction of control module 104, FIG. 9, is shown in FIG. 15. Control module 104 is capable of commanding the other sub-modules as well as executing commands when connected to a remote management unit. Control module 104 includes micro-controller 240 and an EPLD. Control module 104 is programmed with a security shutdown feature to prevent tampering, a remote management unit detect security feature, and functions to control and fault detection through built in tests (BIT) and PBIT. Control module 104 is implemented using 7 external and 2 internal sub-modules the main component of which is micro-controller 240. Control/power module interface 260 monitors the DC power rails, controls the power output, performs security, watchdog, and BIT, implemented in the power supply section. Control/CU communication module (CUCOMM) interface 262 is responsible for proper communication between these two modules. Control/AC power detect module interface 264 is used to allow communication between the remote management unit and control module 104 through CUCOMM module 110 and AC power detection module 112.

Interface 264 allows passing encoded signals to ensure that the remote management unit is present for the operation of the device. Control/CU-S secure module interface 266 allows CU-S secure module 114 to interface with micro-controller 240. Control/UID module interface 268 provides an interface between micro-controller 240 and UID modules 116 which allows each device to have its own unique identity as discussed above. Control/Protocol module interface 270 enables the micro-controller 240 to control the DSP and EPLD functionality and allows micro-controller 240 to cycle power, perform built in security functions, and to perform BITs and PBITS in the device.

Control/RF module interface 272 allows micro-controller 240 to control the vital components of RF module 102 and also allows the immediate shut down of device in case the remote management unit is not detected to prevent the operation of the unit without a remote management unit present, unless part of a secure version. The internal sub-sections of control module 104 include self-test sub-section module 280, which is responsible for monitoring and initiation of all BITs. Self-test sub-section module 280 notifies the appropriate remote manage unit in case of malfunction of the individual device. Self-test sub-section module 280 is implemented in the software inside micro-controller 240. Examples of BIT and PBIT that this unit performs are register probing, base station power test, and TRX functionality.

CU control sub-module 282 is implemented in software in micro-controller 240 and provides power supply control and monitoring, network control, communication and monitoring, CU-S module control, monitoring, and alarm status and RFM control, PM control and monitoring, DSP and EPLD instructions and controls, and power up and cycling.

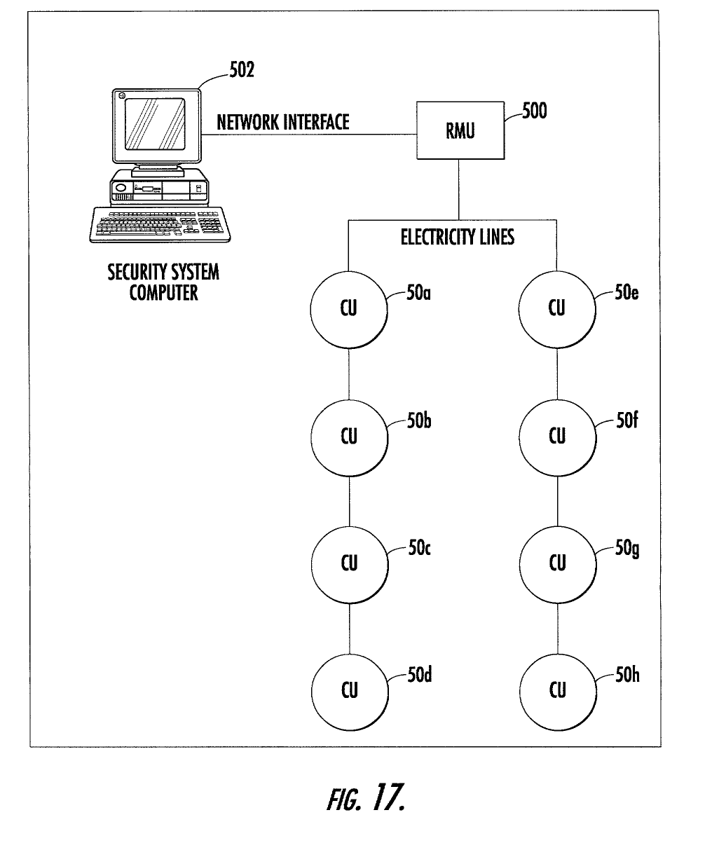

Each control unit 50, FIG. 16 includes receive antenna 100′ and transmit antenna 100″, and housing 400 within includes orifice 402 for power and communication interfacing and which also surrounds and protects the various modules shown in FIG. 9.

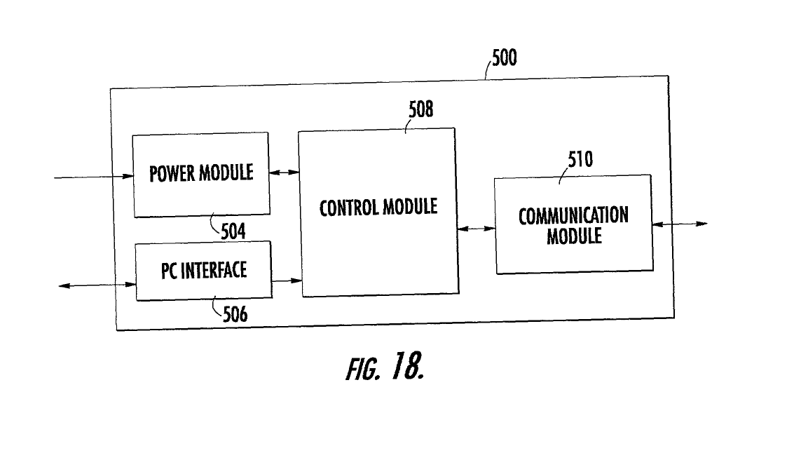

As stated above, in a given facility, there may be a number of control units 50a-50h under the control of RMU 500, FIG. 17 which itself maybe interfaced with security system computer 502. Remote management unit 500 is typically configured to poll the records of selected control modules 50a-50h to track movement of a wireless communication device within any given facility. Security system computer 502 is responsive to one or more remote management units 500 and configured to provide an alarm when a wireless communication device transmits a request for a service transmission.

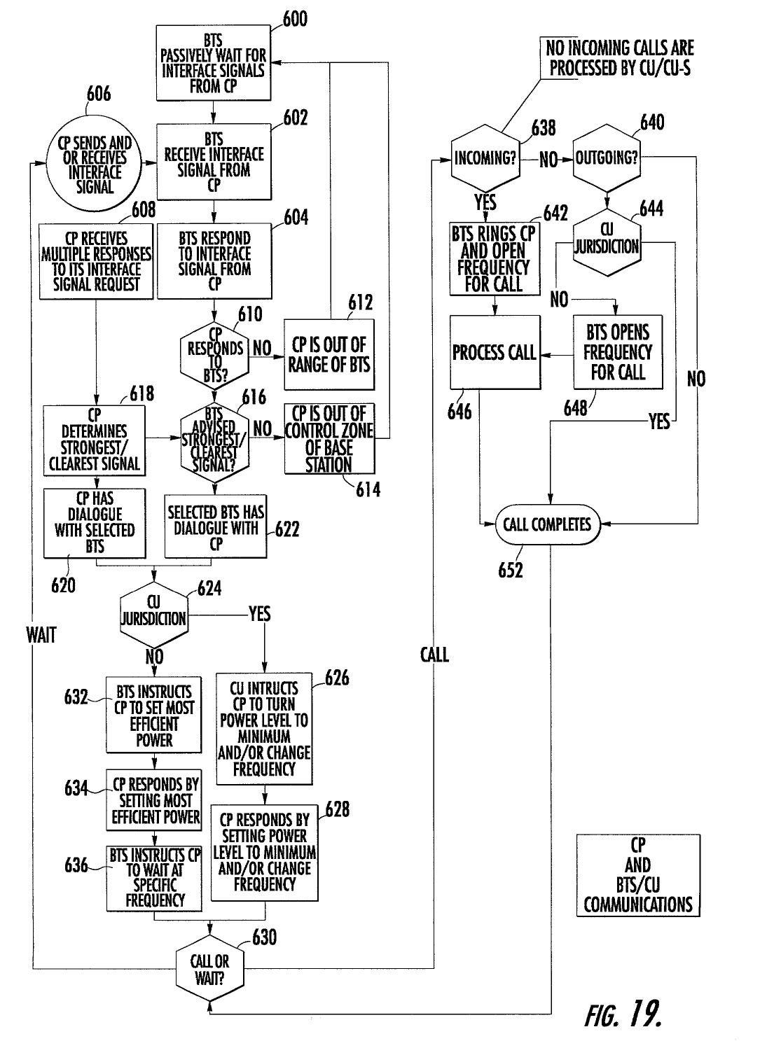

Remote management unit 500, FIG. 17 is shown in more detail in FIG. 18 and includes power module 504, PC interface 506, control module 508, and communication module 510. Communication module 510 is responsible for transmitting and receiving information between remote management unit 500 and each individual control unit 50a-h, FIG. 17. Communication module 510 communicates over the power lines using network protocols providing secure communications. Communication module 510 of remote management unit 500 is similar in many ways to communication module 110, FIG. 9, of an individual control unit 50.

PC interface module 506, FIG. 18, converts data received from each individual control unit 50a-h into a signal that the remote management unit can use to transmit to security system computer 502, FIG. 17 over the existing or proprietary network. If a given customer requests other types of PC communication options, PC interface sub-module 506 processes this data into the appropriate form to provide secure communications and an RJ 45 interface for connection to host computer 502, FIG. 17.

Control module 508, FIG. 18, is responsible for commanding the other modules of remote management unit 500. Control module 508 includes security feature options for enabling and disabling individual control units 50a-h, FIG. 17, enabling and disabling features within each individual control unit, polling the control units in a given system, and downloading the cellular telephone's PIDs from the control units. Power module 504 converts AC power line voltage to DC voltage as required for the operation of the electronic components of the remote management units.

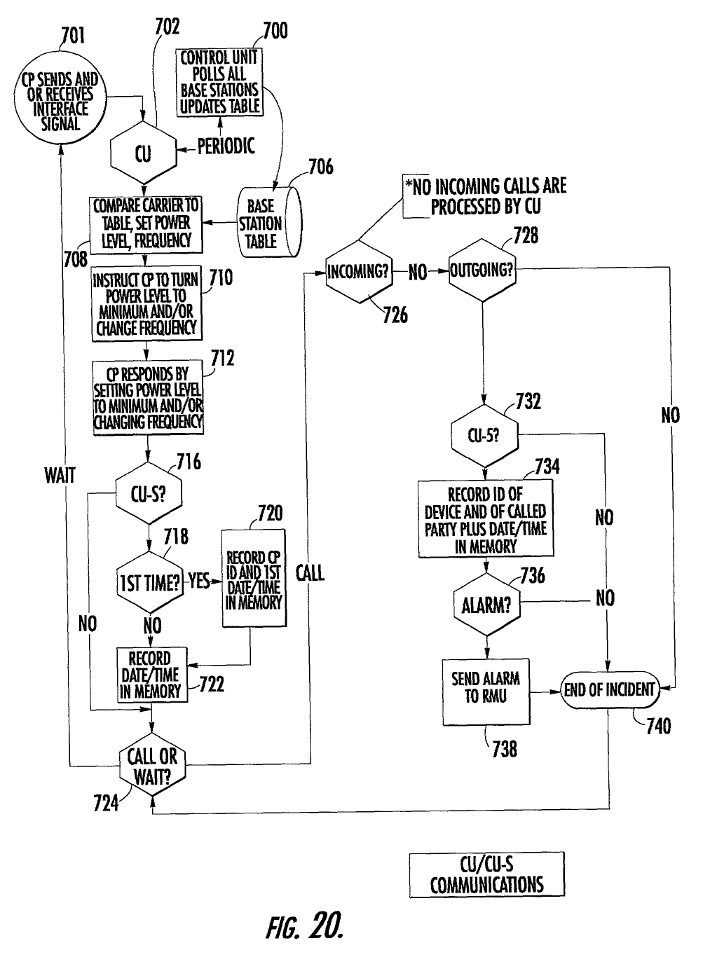

The communication between a CP and a BTS or a CU typically follows a process as outlined in FIG. 19. The process begins as the CP is turned “on” and enters a new BTS/CU jurisdiction. At step 600, BTSs wait and/or send interface signals. At step 606, the CP scans and/or sends an interface signal request while the BTSs passively await an interface signal from the CP. At step 602, one or more of the BTSs receive a new interface signal which contains identification information from the CP and/or a response from their original interface signal. At step 604, one or more of the BTSs respond to the CP's interface signal. At Step 610, the CP determines whether it can respond to at least one BTS signal by measuring the relative field strength of the signal. At step 612, the CP is out of range and is unable to respond; therefore, the CP attempts to reestablish a communication link with a neighboring BTS/CU by cycling to step 600. However if the CP is within the range, at step 616, the CP seeks to determine which BTS has the strongest/clearest signal. At step 614, the neighboring BTSs fail to determine and recommend the strongest/clearest signal because the CP is out of the control zone of the neighboring BTSs. Thus, the CP attempts to reestablish a communication link with a neighboring BTS/CU by cycling to step 600. However, if the CP establishes which BTS has the strongest/clearest signal, at step 622 it establishes a dialogue with that BTS.

At step 608, the CP receives multiple responses from the neighboring BTSs and CUs. At step 618, the CP will determine which BTS/CU is emitting the strongest/clearest recognizable signal. Like step 622, at step 620, the CP establishes a dialog with the neighboring BTS/CU that has the strongest/clearest recognizable signal.

At step 624, CU determines whether a CP is within its communication jurisdiction. To accomplish this task, first the CU polls all of the neighboring base stations' available information such as their power setting and frequency. Then the CU updates its base station table that is stored in its RAM memory or its micro-controller memory. The CU then compares the carrier information to its updated base station table and accordingly sets its power level and frequency. For example, the CU sets it transmission power level to have an absolute field strength greater than the highest measured absolute field strength detected from the corresponding BTS. This allows the CU to determine whether a CP is within its communication territory and to properly communicate with the CP.

If the CU determines that a CP is in its jurisdiction at step 624, the CU interjects, at step 626, and instructs the CP to turn its power level to minimum and/or change its frequency. At step 628, the CP responds to CU's instructions by setting its power level to minimum and/or changing its frequency. At Steps 626, and 628, the CP is no longer in communication with its carrier network.

If the CP is not in the CU jurisdiction, at step 632, the selected BTS instructs the CP to adjust its setting to the most efficient power. At step 634, the CP responds to the selected BTS by adjusting its setting to the most efficient power, and at step 636, the BTS instructs the CP to wait at a specific frequency.

At step 630, the CP is at its call or wait state. When the CP is at its wait stage, steps 600 through 636 are performed. When the CP is in the CU jurisdiction, incoming calls are not processed or received at step 638. If there is an attempt to make an outgoing call at step 640 in the CU jurisdiction, the call will not be processed at step 652. However, if the outgoing call at step 640 is not made in the CU jurisdiction, then at step 648, the BTS opens the frequency for the call and the call is processed at step 646 and completed at step 652.

When the CP is not in the CU jurisdiction, and an incoming call is made to the CP at step 638, the BTS rings the CP and opens the frequency for the call at step 642. At step 646, the call is processed and, at step 652, the call is completed. After completion of the call process, at step 630, the CP returns to its call or wait state.

The control unit (CU) or its secured version (CU-S) typically follows a process as outlined in FIG. 20. At step 700, CU 702 polls all neighboring base stations' available information such as their power setting and frequency. At step 706, CU 702 uses the collected information from step 700 to update its base station table that is stored its RAM memory or its micro-controller memory.

Each CP has specific arrangement of numbers that identifies a specific carrier. At step 708, CU 702 compares the carrier information to its updated base station table and accordingly sets its power level and frequency. For example, the CU sets it transmission power level to have an absolute field strength greater than the highest measured absolute field strength detected from the corresponding BTS. This allows CU 702 to determine whether a CP is within its communication jurisdiction and to properly communicate with the CP.

At step 710, CU 702 instructs the CP to turn its power level to minimum and/or change its frequency. At step 712, the CP responds by setting its power level to minimum and/or changing its frequency.

The purpose of a secured control unit (CU-S) is to record any cellular telephone activity and possibly alert the proper authority if there is a breach in the security. CU-S 716, at step 718, first determines whether a particular CP has been in its jurisdiction previously. The first time that the CP is “turned on” in CU-S 716 jurisdiction, at step 720, CU-S 716 records the date, the time and the CP's identification in its memory. However, if the CP was in CU-S 716 jurisdiction previously, at step 722 it records only the date and the time that the “turned on” CP enters its jurisdiction again. In summary, the purpose of steps 716 through 722, in this embodiment, is to record the identity, the date and the time of any CP that is “turned on” in CU-S 716 jurisdiction.

At step 724, the CP is at its call or wait state. When the CP is at its wait stage, steps 700 through 722 are performed. When the CP is in the CU-S jurisdiction, incoming calls are not processed or received at step 726. If there is an attempt to make an outgoing call at step 732 in CU-S 732 jurisdiction, at step 734, CU-S 732 records the identification of the CP, the identification of the called party, the time and the date in its memory. At step 736, CU-S 732 decides whether to send an alarm. At step 738, CU-S 732 sends an alarm to the RMU and the incident ends at step 740.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments.

Other embodiments will occur to those skilled in the art and are within the following claims:

What is claimed is:

1. A method of intervening between a wireless communication device and a base station, the method comprising:
employing a receiver to scan for transmissions from multiple surrounding base stations;
measuring the absolute field strength of all received transmission and recording the information transmitted by the base stations;
setting the transmission power level of a transmitter to have an absolute field strength greater than the highest measured absolute field strength detected from a corresponding base station;
receiving an interface signal from a wireless communication device; and
transmitting to the wireless communication device the corresponding information to thereafter control the wireless communication device by establishing a communication channel between the wireless communication device and the receiver and transmitter instead of between the wireless communication device and a surrounding base station to prevent use of the wireless communication device proximate the receiver and transmitter.

2. The method of claim 1 in which the step of transmitting includes instructing the wireless communication device to lower its transmission power so that transmissions from the wireless communication device do not reach any corresponding surrounding base stations.

3. The method of claim 1 in which the step of transmitting includes instructing the wireless communication device to transmit at a frequency not recognized by any corresponding surrounding base stations.

4. The method of claim 1 further including the step of keeping a record of all interface signals and requests for service transmissions received from a wireless communication device.

5. The method of claim 4 further including the step of polling the record to track movement of a wireless communication device.

6. The method of claim 1 further including the step of providing an alarm when a wireless communication device transmits a request for service transmission.

7. The method of claim 1 in which the step of transmitting includes instructing the wireless communication device to undertake processes to remove itself from normal communication with a cellular telephone service provider.

8. A method of intervening between a wireless communication device and a base station, the method comprising:
employing a receiver to scan for transmissions from multiple surrounding base stations;
receiving an interface signal from a wireless communication device; and
transmitting to the wireless communication device the corresponding information to thereafter control the wireless communication device by establishing a communication channel between the wireless communication device and the receiver and transmitter instead of between the wireless communication device and a surrounding base station to prevent use of the wireless communication device proximate the receiver and transmitter.

9. The method of claim 8 in which the step of establishing a communication channel includes measuring the absolute field strength of all received transmissions and recording the information transmitted by the base stations.

10. The method of claim 9 in which transmitting includes setting the transmission power level of a transmitter to have an absolute field strength greater than the highest measured absolute field strength detected from a corresponding base station.

11. A communication device intervention system comprising:
an antenna;
a receiver responsive to transmissions received by the antenna;
a transmitter; and
a control module responsive to the receiver and connected to the transmitter, the control module configured to:
measure the absolute field strength of all received transmissions detected by the receiver from surrounding base stations,
record the information transmitted by the surrounding base stations,
set the transmission power level of the transmitter to have an absolute field strength greater than the highest measured absolute field strength detected from a corresponding base station,
detect an interface signal received by the transmitter from a wireless communication device in a predefined area proximate the receiver, and
transmit, at the set absolute field strength, the corresponding information to the wireless communication device so that the system prevents use of the wireless communication device in the predefined area.

12. The system of claim 11 in which the control module is further configured to transmit to the wireless communication device a signal which instructs the wireless communication device to lower its transmission power so that transmissions from the wireless communication device do not reach any corresponding surrounding base stations.

13. The system of claim 11 in which the control module is further configured to transmit to the wireless communication device a signal which instructs the wireless communication device to transmit at a frequency not recognized by any corresponding surrounding base stations.

14. The system of claim 11 in which the control module is further configured to transmit to the wireless communication device to undertake to remove itself from normal communication with a cellular telephone service provider.

15. The system of claim 11 in which the control module is further configured to record all interface signals and requests for service transmissions received from a wireless communication device.

16. The system of claim 13 further including a remote management unit configured to poll the records of a selected group of control modules to track movement of a wireless communication device.

17. The system of claim 16 further including a system computer responsive to the remote management unit and configured to provide an alarm when a wireless communication device transmits a request for service transmission.

18. A communication device intervention system comprising:
an antenna;
a receiver responsive to transmissions received by the antenna;
a transmitter; and
a control module responsive to the receiver and connected to the transmitter, the control module configured to:
record the information transmitted by the surrounding base stations,
detect an interface signal received by the receiver from a wireless communication device in a predefined area proximate the receiver, and
transmit the corresponding information to the wireless communication device so that the system prevents the use of the wireless communication device in the predefined area.

19. The communication device intervention system of claim 18 in which the transmitter has an adjustable power level.

20. The communication device intervention system of claim 18 in which the control module is configured to measure the absolute field strength of all received transmissions detected by the receiver from the surrounding base stations.

21. The communication device intervention system of claim 20 in which the control module is further configured to set the transmission power level of the transmitter to have an absolute field strength greater than the highest measured absolute field strength detected from a corresponding base station.

22. The communication device intervention system of claim 21 in which the control module is configured to transmit at the set absolute field strength.

23. A system for intervening between a communication device and a base station, the system comprising:
a plurality of control units each having:
an antenna,
a receiver responsive to transmissions received by the antenna,
a transmitter having an adjustable power level, and
a control module responsive to the receiver and connected to the transmitter, the control module configured to:
measure the absolute field strength of a received transmission detected by the receiver from surrounding base stations,
record the information transmitted by the surrounding base stations,
set the transmission power level of the transmitter to have an absolute field strength greater than the highest measured absolute field strength detected from a corresponding base station,
detect and record an interface signal received by the receiver from a wireless communication device in a predefined area proximate the receiver, and
transmit, at the set absolute field strength, the corresponding information to the wireless communication device so that the system prevents the use of the wireless communication device in the predefined area;
a remote management unit linked to the plurality of control units for polling the records of the control units to track movement of the wireless communication device; and
a system computer responsive to the remote management unit for providing an alarm when the wireless communication device transmits a request for service transmission.

24. The system of claim 23 in which the remote management unit is linked to the plurality of control units via AC power lines.

25. The system of claim 23 in which there are a plurality of remote management units each linked to a subset of the control units and the system computer is linked to the plurality of remote management units.
